(19) United States
(12) Patent Application Publication
(10) Pub. No.: US 2005/0145182 A1
(43) Pub. Date: Jul. 7, 2005

(54) Helical perch bird feeder

(76) Inventor: Patrick Thomas Marshall, Tipp City, OH (US)

Correspondence Address: KENYON & KENYON, 1500 K STREET, N.W., SUITE 700, WASHINGTON, DC, 20005, US

(21) Appl. No.: 10/960,964

(22) Filed: Oct. 12, 2004

Related U.S. Application Data
(60) Provisional application No. 60/533,501, filed on Jan. 2, 2004.

(51) Int. Cl. A01K 39/01

(52) U.S. Cl. 119/57.8

(57) ABSTRACT

A bird feeder that includes a container having top and bottom ends spaced apart in a first direction, and a cylindrical wall surrounding a central region between the top and bottom ends to hold bird feed. The container also includes a plurality of feeding openings in the wall to provide access to the bird feed in the container. The plurality of feeding openings are spaced at a respective distance from the top end toward the bottom end. The bird feeder also includes a generally helical member having a first end portion and a second end portion. The helical member is wound around the container in a spiral manner along a generally helical path between the top and bottom ends. Top and bottom caps are also provided to close the top and bottom ends of the bird feed container. Both the top and bottom caps can be removed from the container.

### BACKGROUND

[1] The present invention relates to bird feeders and, more specifically, to an improved bird feeder having a container with feeding openings and a generally helical member surrounding the container.

### OBJECTS OF THE INVENTION

It is an object of the invention to provide an improved bird feeder having a container with feed ports and a generally helical perch extending spirally along the container to provide access to seed.

Another object is to provide a bird feeder suitable for varied sizes and species of birds.

Another object is to provide a bird feeder having a plurality of ports spaced in a spiral manner and a single, generally helical member configured to serve as a perch adjacent to the ports.

It is still another object to provide a helical perch with end stops to help stabilize and to properly position the perch with respect to the seed container.

It is yet another object to provide a feeder having a locking means for all caps to prevent rodents access to seed.

It is an object of the invention to provide a simplified, quick cleaning means by use of removable caps.

It is an object of the invention to provide a bird feeder with a seed tray with attachment means to the bottom cap.

These and other objects of the invention will become apparent from the following description, drawings and claims.

### SUMMARY OF THE INVENTION

An improved bird feeder in accordance with this invention includes a feed container that has a wall surrounding a central region and a plurality of feeding openings, or ports, in the wall through which birds are allowed access to bird feed stored inside the container. The feeder has a hollow body for receiving and storing bird feed. The ports are spaced apart along the length of the container between the ends thereof, and are so located that a generally helical member extending around and along the body passes near each of the ports. These feeding ports are provided to allow birds access to the feed contained in the central cavity area.

The feed is retained in the body by providing a sealing means for the top and bottom of the feeder. The helical member is spaced from the container by a distance that allows birds perched on it to reach into each port and withdraw bird feed. The distance from the part of the perch closest to an access port is suitable for small birds, while larger birds can accommodate themselves by positioning their bodies somewhat upwards or downwards along the perch from the access ports.

Using preformed wire or plastic wire, the helical perch can be attached to near the top and near the bottom of the container. For non-preformed perches, support pegs may be utilized and fixedly attached to the container to shape the non-preformed perch at a predetermined distance and position from the container. Stops near each end of the helical perch help to properly position and to stabilize the perch once it is attached to the container.

The top cap of the feeder has a locking mechanism securing it to the container. The top cap can be locked or unlocked simply by rotating the cap in place. If the top cap is rotated to lock, it prevents rodents from gaining access to seed contained therein. If it is rotated to unlock, the top cap can then be lifted up and out of the feeder along a hanging means to allow feed to be inserted into the central cavity of the feeder. The bottom of the feeder has a similar locking mechanism. If the bottom cap is rotated to lock, then it helps to support the seed. If it is rotated to unlock, the bottom cap can then be pulled down and out freely from the bottom of the feeder to allow cleaning of the feeder parts.

An optional seed tray can also be attached to the bottom cap to help catch uneaten seed and empty husks. The feeder is hung by a cable or wire that is attached directly to the perch through the top cap which allows the feeder to be hung from a suitable tree or other site, thus allowing the enjoyment of watching birds eat.

The invention will be described in greater detail in connection with the drawings, in which like serial numbers in different figures indicate the same item.

### BRIEF DESCRIPTION OF THE DRAWINGS

FIG. 1 is a perspective view of a helical perch bird feeder with detachable top and bottom caps according to one embodiment of the present invention.

FIG. 2 is a cross-sectional exploded view of the helical perch bird feeder along line 2-2 shown in FIG. 1.

FIG. 3 is a cross-sectional view of the top cap of the helical perch bird feeder along line 3-3 shown in FIG. 1.

FIG. 4 is a cross-sectional view of the bottom cap of the helical perch bird feeder along line 4-4 shown in FIG. 1.

FIG. 5 is a top view of the base plate used in the bottom cap as shown in FIG. 1.

FIG. 6 is a cross-sectional view of the base plate along line 6-6 shown in FIG. 5.

FIG. 7 is a cross-sectional view of the base plate along line 7-7 shown in FIG. 5

FIG. 8 is a top view of the seed tray illustrated as being attached to the bottom cap in FIG. 1.

FIG. 9 is a cross-sectional view of the seed tray along line 9-9 shown in FIG. 8.

FIG. 10 is a top view of the top cap shown as being attached to the top of the cylindrical body of the bird feeder in FIG. 1.

FIG. 11 is a cross-sectional view of the top cap along line 11-11 shown in FIG. 10.

FIG. 12 is a top view of the bottom cap shown as being attached to the bottom of the tube feeder in FIG. 1.

FIG. 13 is a cross-sectional view of the bottom cap along line 13-13 shown in FIG. 12.

FIG. 14 is a top view of the relaxed helical perch used in FIGS. 1-4.

### DETAILED DESCRIPTION

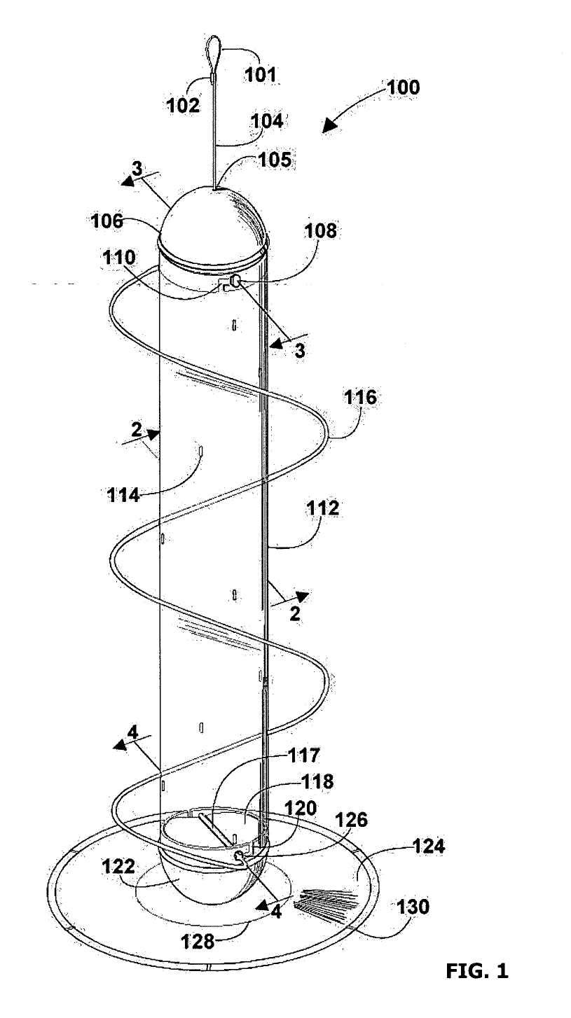

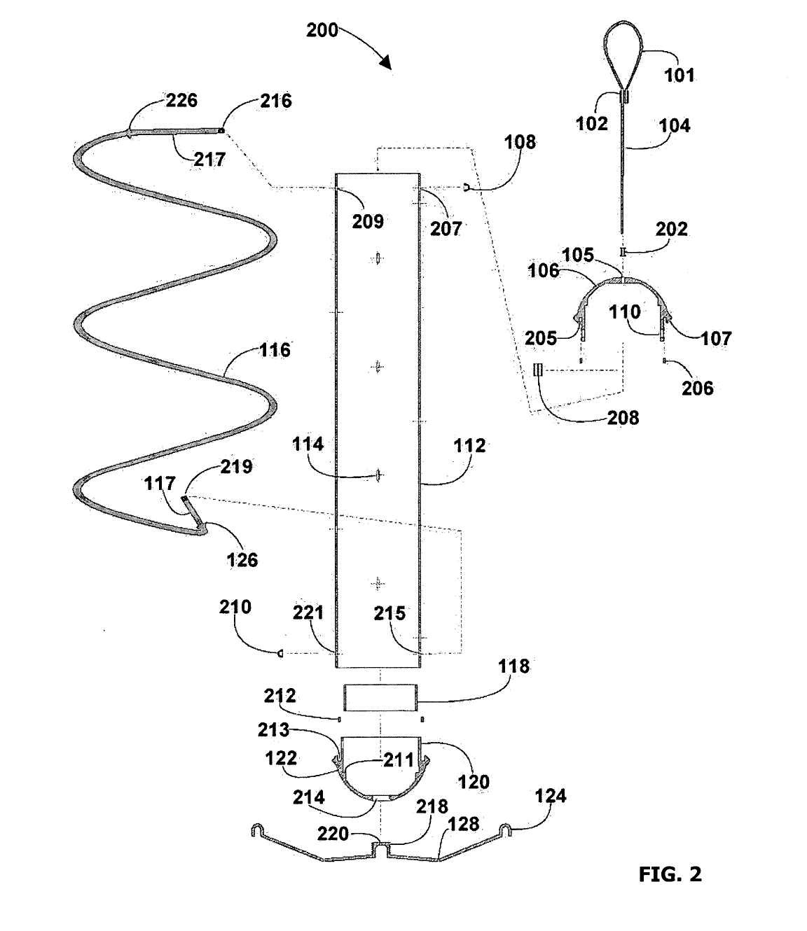

FIG. 1 and FIG. 2 illustrate a bird feeder 100 according to one embodiment of the present invention. The bird feeder 100 includes a seed container that has a hollow tubular body 112 surrounding a central region into which a quality of seed can be poured. The hollow tubular body 112 can be cast or molded from such material as transparent butyrate, poly-carbonate, and the like. The tubular body 112 can also be cut from a longer plastic tube into sections having the hollow tubular body 112 dimensions.

According to one embodiment, the container is round, and the wall has a plurality of feeding openings, or feed ports, 114 spaced apart longitudinally along the body 112 and angularly around it relative to an arbitrary plane through the axis of the tubular body 112. These feed ports 114 are positioned to generally follow the same path directionally as a helical perch 116. The feed ports 114 can be formed into the hollow tubular body 112 by the mechanical means of a stamping process.

The bird feeder 100 also includes the helical perch 116, which is wound helically around the hollow tubular body 112. The helical perch 116 can be made of either plastic or metal materials. If it is made of plastic, then a suitable UV-resistant and rodent-resistant material like poly-carbonate could be used. The shape of the plastic helical perch 116 can be formed using a plastic-injection process. If metal is chosen for the helical perch 116 then a rust-resistant material like stainless steel should be utilized. The shape of the metal helical perch 116 can be formed using a process similar to that, which is used to form the shape of coil springs.

A first cable ferrule 102 forms a top cable loop 101 for a cable 104, which comprises part of the hanging means of the bird feeder 100. The first cable ferrule 102 must be crimped with a tight clamping force with a crimping tool, or the like, for the purpose of forming the top cable loop 101. The bottom end of the cable 104 is inserted through a small grommet hole 105 in removable top cap 106 which is then securely fastened to the helical perch 116 inside the removable top cap 106. The bird feeder 100 may be hung by the hanging means, which is partially shown in FIG. 1, to a post, to a side of a house, or in the branches of a tree. The removable top cap 106 protects the seed inside the bird feeder 100 from the environment and rodents. The portion below the top cap 106 is an overhang 107, which is made larger than the hollow tubular body's 112 outside diameter. The overhang 107 helps to prevent moisture runoff from the outer surface of top cap 106 from seeping into the inside of the tubular body 112.

The removable top cap 106 has a top locking slot 110 that can be punched, stamped, or formed into the body of the removable top cap 106. Once the removable top cap 106 is fully seated into the hollow tubular body 112, the removable top cap 106 can then be rotated laterally in-place-counter clockwise, as viewed from the top, to lock the removable top-cap 106 in place to the helical perch 116. This prevents rodents from lifting the removable top cap 106 off to gain access to any bird seed contained within the hollow tubular body 112. The top locking slot 110 also helps prevent the removable top cap 106 from inadvertently falling out and spilling the contents contained within the hollow tubular body 112 in the event of accidentally dropping the bird feeder 100 to the ground.

A first female threaded cap nut 108 is secured to the top of the helical perch 116 as a means to fasten the helical perch 116 to the hollow tubular body 112. The helical perch 116 has bottom perch stops 126, which are molded or machined into the helical perch 116 to help stabilize the helical perch's position with respect to the outer diameter of the hollow tubular body 112. These perch stops 126 help keep the helical perch 116 stable as a whole, with its own position with respect to the distance from the outer walls of the hollow tubular body 112. The bottom perch stop 126 can also be crimped or molded directly into the helical perch 116.

The bottom of the bird feeder 100 has a removable bottom cap 122 that is very similar to the removable top cap 106. The removable bottom cap 122 can be locked and unlocked in place by the use of a bottom locking slot 120. The bottom locking slot 120 provides a similar use as the top locking slot 110. Additionally, the bottom locking slot 120 also makes it easier to clean the inside of the bird feeder 100.

The removable bottom cap 122 includes a removable base piece 118. The removable base 118 helps prevent seed from entering the bottom cap 122. The helical perch 116 has a bottom perch straight end 117 that also helps prevent seed from falling through to the removable bottom cap 122. However, moisture buildup is allowed to run through small gaps left by the space between the bottom perch straight end 117 and a slot that is molded into the center of the removable base piece 118.

A seed tray 124 can be attached to the removable bottom cap 122 to help catch spilled seed and empty shells. The seed tray 124 has a plurality of external drain holes 128 for allowing water buildup to leak out. In addition, a plurality of seed tray gussets 130 is molded into the seed tray for additional strength.

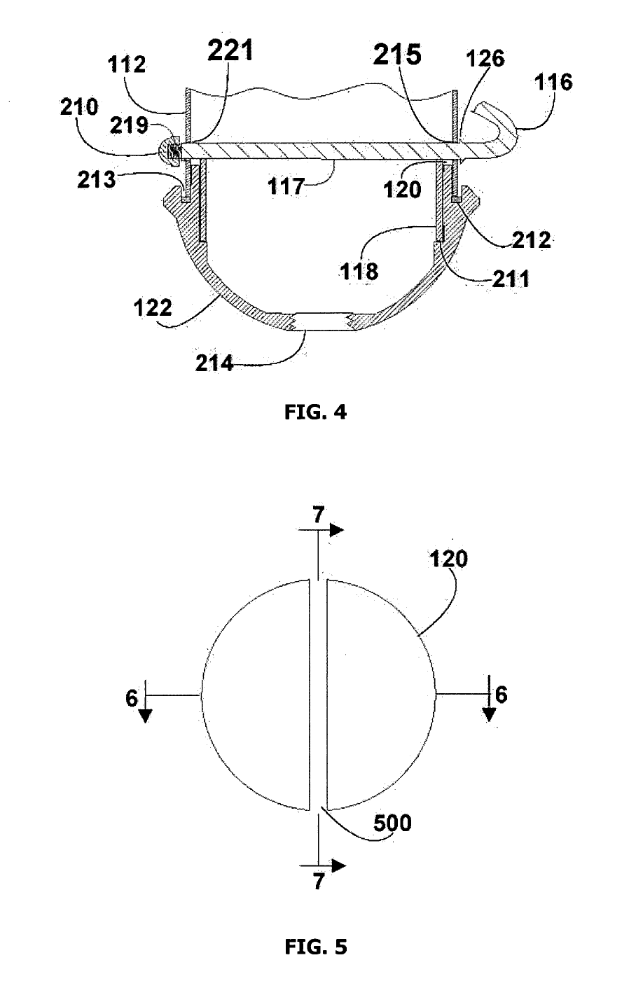

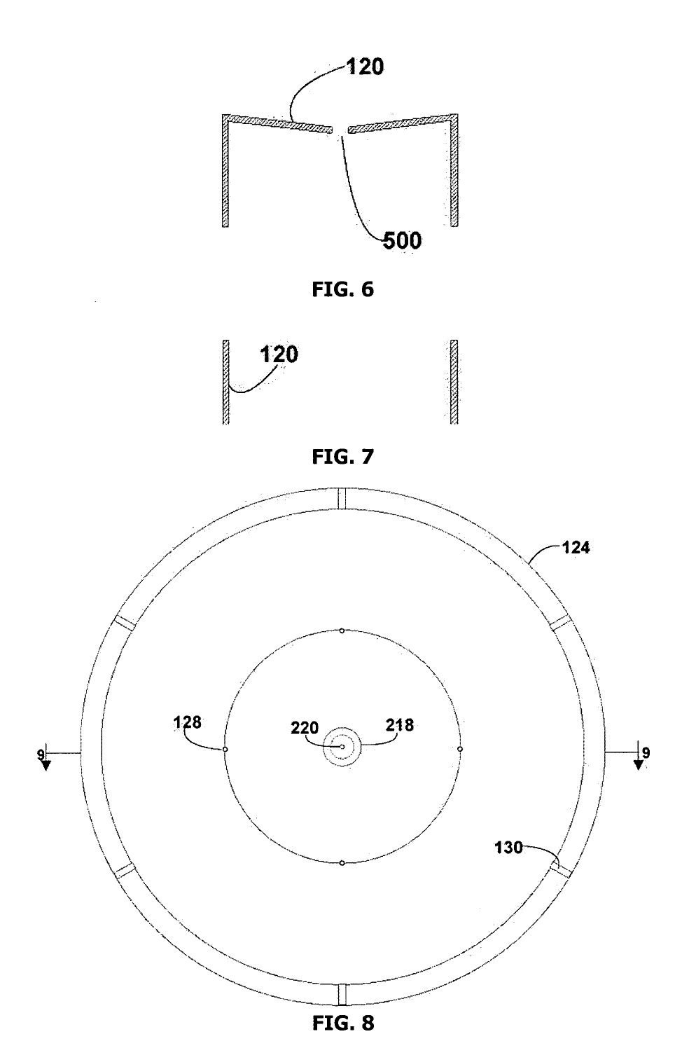

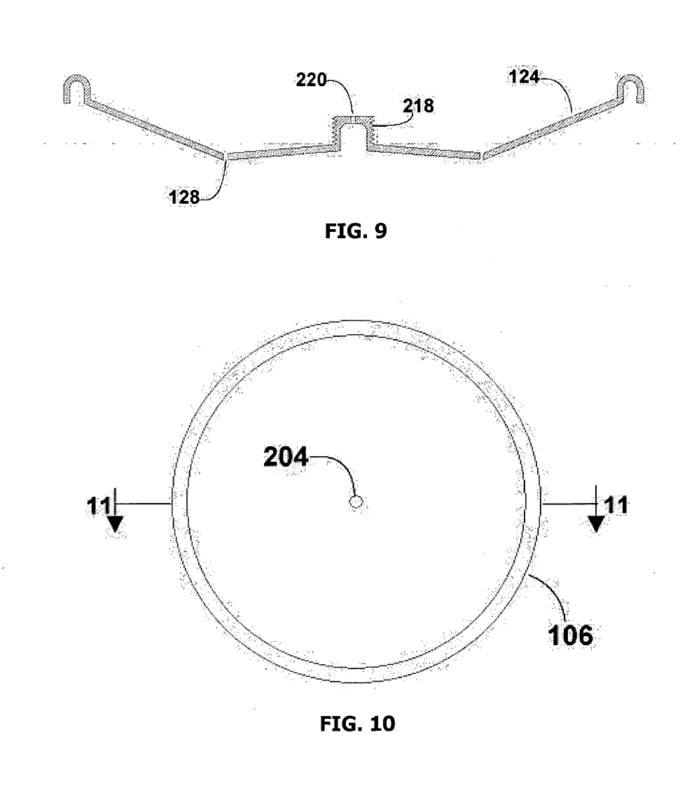

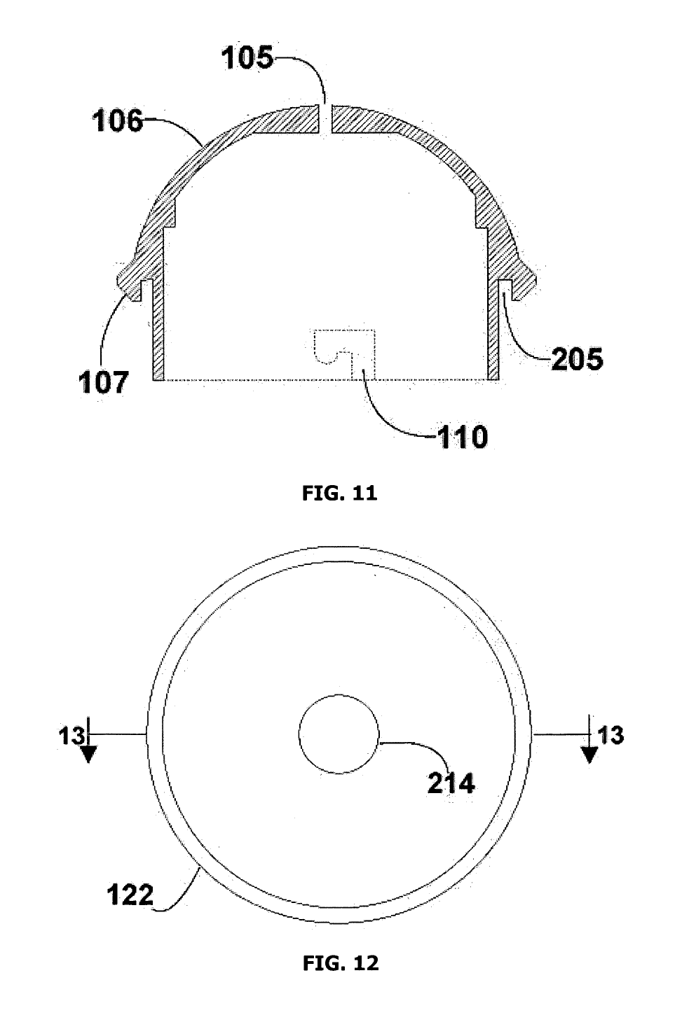

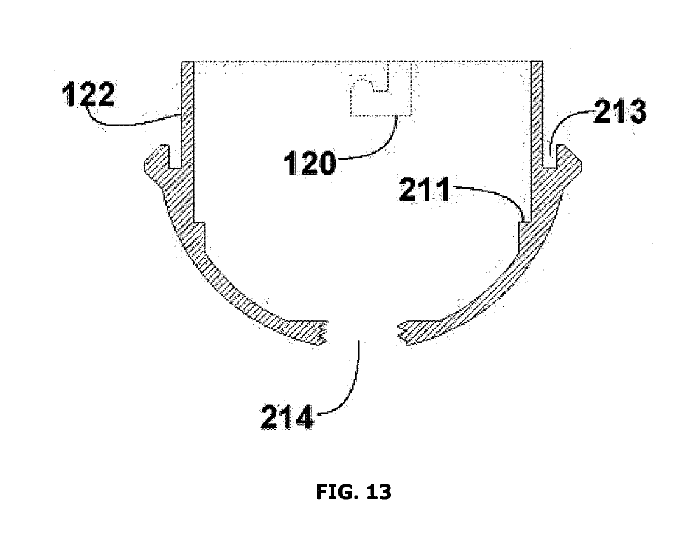

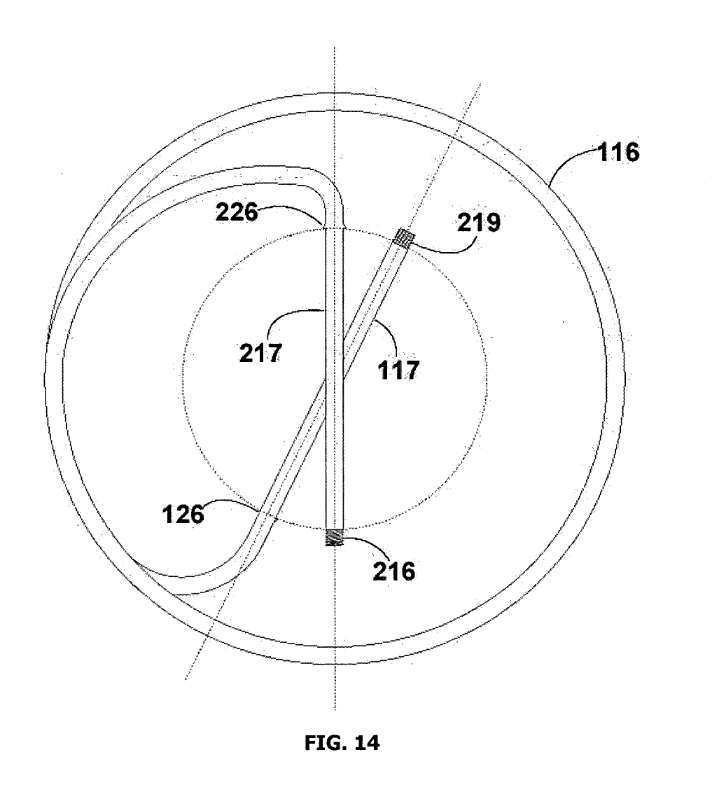

FIGS. 2-14 illustrate the assembly of the bird feeder 100 in detail. In particular, FIG. 2 depicts a cross-sectional view of the bird feeder 100 along line 2-2 shown in FIG. 1. To help prevent moisture from seeping into the hollow tubular body 112, a first o-ring 206 is inserted into a top tube slot 205 in the top cap 106. The cable 104 can be partially pre-assembled by having the top cable loop 101 formed prior to assembly by the use of first cable ferrule 102. These partially assembled parts help speed up the final assembly process of bird feeders 100 in FIG. 1. Prior to the insertion of cable 104, a rubber cable grommet 202 is inserted into the removable top cap 106. The purpose of this cable grommet 202 is twofold: (1) to help prevent moisture from seeping into the hollow tubular body 112 from the top of removable top cap 106; and (2) to help prevent chafing of the plastic coating of cable 104 from the edges of the grommet hole 105. The lower end of cable 104 can then be inserted through the cable grommet 202 and removable top cap 106.

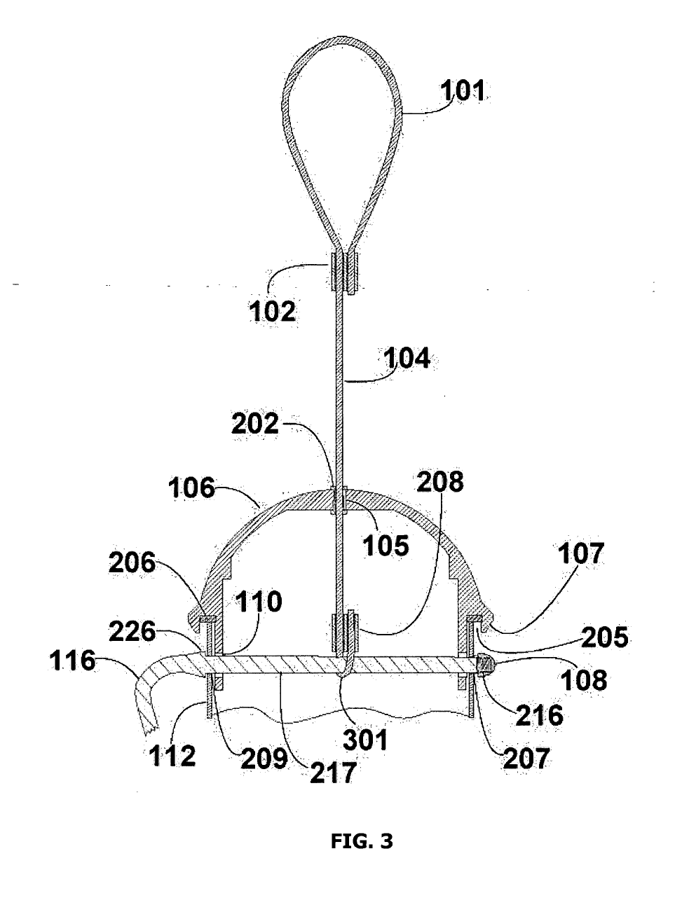

Once this is accomplished, a bottom cable loop 301 is formed by the use of a second cable ferrule 208 as illustrated in FIG. 3. The bottom cable loop 301 is then slid over a perch straight end 217 of the helical perch 116. This is accomplished after the perch straight end 217 is inserted into a first top perch hole 209 that is punched or formed into the top portion of the hollow tubular body 112. The straight end 217 is inserted across the hollow tubular body 112 and through a second top perch hole 207 until a top perch stop 226 prevents the straight end 217 from proceeding further through the top perch holes 209 and 207 in the hollow tubular body 112.

The first female threaded cap nut 108 can then be screwed onto the top threaded male perch end 216. The uncoiled helical perch 116 may then be inserted into the bottom end of the hollow tubular body 112. This is accomplished by uncoiling and stretching the helical perch 116 vertically until the bottom end part of the perch 116 can be inserted safely through similar bottom perch holes 215 and 221 in the bottom of the hollow tubular body 112. However, the bottom of the helical perch 116 is now inserted from the opposite side of the hollow tubular body 112 through the first bottom perch hole 215 and continues on across the hollow tubular body 112 until it passes through the second bottom perch hole 221. At this point, the bottom perch stop 126 prevents the helical perch 116 from proceeding further through the holes 215 and 221 in the lower part of the hollow tubular body 112. A second female threaded cap nut 210 can then be screwed onto the bottom threaded male perch end 219 to hold the helical perch 116 firmly in place to the hollow tubular body 112. The top cap 106 can now be inserted into the top of the hollow tubular body 112 and turned to lock in place.

The bottom cap 122 has a preformed bottom tube slot 213 into which a second o-ring 212 is inserted. The removable base plate 118 is then inserted in the bottom cap 122 until it rests against a base stop 211. As shown in FIG. 5, the removable base plate 118 has a base plate slot 500 that has to be aligned parallel to the bottom perch straight end 117. The bottom cap 122 with the second o-ring 212 and the removable base plate 118 are then inserted up into the inside of the hollow tubular body 112 and turned to lock in place against the bottom perch straight end 117.

For catching fallen seed and husks, an optional seed tray 124 can be attached to the bottom cap 122. Part of the seed tray 124 has a pre-formed threaded male seed tray protrusion 218 that is screwed into a thread female seed tray hole 214 that is milled or molded into the bottom cap 122. The seed tray 124 has an inner drain hole 220 to help prevent water buildup inside the bottom cap 122. The material used for the seed tray 124 and removable base piece should be clear plastic poly-carbonate material that has an UV inhibitor. These materials allow for both parts to be manufactured using standard plastic-injection techniques.

The o-rings 212, 206 and the cable grommet 202 can be molded as rubber parts with UV inhibitors. The removable top and bottom caps 106 and 122 can be manufactured out of metals such as cast, corrosion resistant aluminum, or a plastic material like UV-resistant PVC or ploy-carbonate. The cap nuts 108 and 210 should be made of a rust-resistant material such as stainless steel.

The cable ferrules 102 and 202 should be made of any corrosion-resistant metal material, such as aluminum, that forms a tight clamping force to the cable 104 once the first cable ferrule 102 is crimped with a crimping tool, or the like, for the purpose of forming the top cable loop 101. For safety reasons, the cable 104 must be manufactured using multiple strands of intertwined and twisted steel wires that when combined, formulate a tensile strength of at least 150 pounds of holding force to prevent any injures that may be caused by a breakage in the cable 104. A plastic coating can be applied to the exterior of the cable 104 to protect it from the environment.

Prior to assembly, the helical perch 116 is formed in the shape of a coiled large spring with straight lengths at its ends for insertion through holes in top and bottom portions of the hollow tubular body 112.

Several embodiments of the present invention are specifically illustrated and described herein. However, it will be appreciated that modifications and variations of the present invention are covered by the above teachings and within the purview of the appended claims without departing from the spirit and intended scope of the invention.

1. A bird feed container, comprising:
a cylindrical wall having top and bottom ends;
a plurality of feeding openings provided in the wall;
a perch wound around the wall along a generally helical path between the top and bottom ends, the perch having first and second ends;
top and bottom caps provided on respective ends of the wall; and
a base piece provided near the bottom end of the wall to prevent seed from entering the bottom cap.

2. The bird feed container of claim 1, wherein the top and bottom caps are removable.

3. The bird feed container of claim 1, further comprising:
first receiving means provided adjacent to the top end of the wall to hold the first end of the perch; and
second receiving means provided adjacent to the bottom end of the wall to hold the second end of the perch.

4. The bird feed container of claim 1, wherein the top cap further comprises locking means to secure the top cap in place with the cylindrical wall.

5. The bird feed container of claim 4, wherein the locking means further comprises:
a locking slot to receive the first end of the perch, the locking slot aligned to face the first receiving means such that the first end of the perch is received through the first receiving means and the locking slot of the top cap;
an edge overlapping the top end of the cylindrical wall; and
a threaded nut to be secured to the first end of the perch.

6. The bird feed container of claim 1, wherein the bottom cap further comprises locking means to secure the bottom cap in place with the cylindrical wall.

7. The bird feed container of claim 6, wherein the locking means further comprises:
a locking slot to receive the second end of the perch, the locking slot aligned to face the second receiving means such that the second end of the perch is received through the second receiving means and the locking slot of the bottom cap;
an edge overlapping the bottom end of the cylindrical wall; and
a threaded nut to be secured to the second end of the perch.

8. The bird feed container of claim 1, wherein the base piece is removable.

9. The bird feed container of claim 1, wherein the base piece further comprises a slot to secure the second end of the perch between the bottom cap and the bottom end of the wall.

10. The bird feed container of claim 1, wherein moisture is allowed to flow through the base piece.

11. The bird feed container of claim 1, wherein the perch is positioned relative to at least one of the feeding openings.

12. The bird feed container of claim 1, wherein the perch further comprises top and bottom perch stops to secure the perch relative to the cylindrical wall.

13. The bird feed container of claim 1, further comprising hanging means to suspend the bird feeder from any suitable support.

14. The bird feeder of claim 13, wherein the hanging means further comprises:
a loop portion to hang the bird feed container;
a center portion to be inserted through cable receiving means of the top cap; and
an end portion to be securely fastened to the first end of the perch.

15. The bird feeder of claim 14, further comprising a cable grommet placed between the cable receiving means of the top cap and the center portion of the hanging.

16. The bird feeder of claim 1, further comprising a seed tray to be attached to the bottom cap to catch spilled seed and empty husks.

17. A bird feeder, comprising:
a hollow body having a top end and a bottom end,
a plurality of feeding openings provided in the hollow body;
top and bottom caps provided on respective ends of the hollow body; and
a base piece provided near the bottom end of the hollow body to prevent seed from entering the second cap.

18. The bird feeder of claim 17, wherein the hollow body is cylindrical.

19. The bird feeder of claim 17, wherein the top and bottom caps are removable.

20. The bird feeder of claim 17, wherein the base piece is removable.

21. The bird feeder of claim 20, wherein moisture is allowed to flow through the base piece.

22. The bird feeder of claim 17, further comprising hanging means to suspend the bird feeder from any suitable support.

23. The bird feeder of claim 17, further comprising a generally helical member being wound in the hollow body in a spiral manner between the top and bottom ends.

24. A bird feeder, comprising:
a hollow body having a top end and a bottom end;
top and bottom receiving means provided in respective ends of the hollow body;
a plurality of feeding openings provided in the hollow body;
top and bottom caps provided on respective ends of the hollow body;
a generally helical member being wound around the hollow body between the top and bottom ends, the generally helical member having a first portion extending through the top receiving means of the hollow body; and
the first portion of the generally helical member having first and second stopping means to maintain the generally helical member in place with the hollow body.

25. The bird feeder of claim 24, wherein the first stopping means is formed into the first portion of the generally helical member.

26. The bird feeder of claim 24, wherein the first stopping means is molded into the first portion of the generally helical member.

27. The bird feeder of claim 24, wherein the first stopping means is machined into the first portion of the generally helical member.

28. The bird feeder of claim 24, wherein the first stopping means is crimped into the first portion of the generally helical member.

29. The bird feeder of claim 24, wherein the second stopping means is secured to the first portion of the generally helical member.

30. The bird feeder of claim 24, wherein the second stopping means is a threaded cap nut.

31. The bird feeder of claim 24, further comprising a base piece provided between the bottom cap and the bottom end of the hollow body to prevent seed from entering the bottom cap.

32. The bird feeder of claim 31, wherein the base piece is removable.

33. The bird feeder of claim 31, wherein moisture is allowed to flow through the base piece.

34. The bird feeder of claim 31, wherein the base piece further comprises a slot to secure the generally helical member between the bottom cap and the bottom end of the hollow body.

35. The bird feeder of claim 24, wherein the hollow body is cylindrical.

36. The bird feeder of claim 24, wherein the top and bottom caps are removable.

37. The bird feeder of claim 24, wherein the generally helical member is positioned relative to at least one of the feeding openings to define a perch.

38. The bird feeder of claim 24, further comprising hanging means to suspend the bird feeder from any suitable support.

39. The bird feeder of claim 38, wherein the hanging means further comprises:
a loop portion to hang the bird feeder;
a center portion to be inserted through cable receiving means of the top cap; and
an end portion to be securely fastened to the first portion of the generally helical member.

40. The bird feeder of claim 39, further comprising a cable grommet placed between the cable receiving means of the top cap and the center portion of the hanging means.

41. The bird feeder of clam 24, wherein the top cap further comprises:
a receiving slot to receive the top end of the hollow body;
an overhang provided to fit at least partially over the top end of the hollow body; and
an O-ring to be inserted inside the receiving slot and to receive the top end of the hollow body.

42. The bird feeder of claim 24, wherein the top cap further comprises a locking slot to receive the first portion of the generally helical member, the top cap being aligned in a predetermined manner, such that, in its locked position, the first portion of the generally helical member is received through the locking slot and the top receiving means of the hollow body.

43. The bird feeder of claim 24, wherein the generally helical member further comprises a second portion extending through the bottom receiving means of the hollow body, the second portion of the generally helical member having first and second stopping means to maintain the generally helical member in place with the hollow body.

44. The bird feeder of claim 43, wherein the first stopping means is formed into the second portion of the generally helical member.

45. The bird feeder of claim 43, wherein the first stopping means is molded into the second portion of the generally helical member.

46. The bird feeder of claim 43, wherein the first stopping means is machined into the second portion of the generally helical member.

47. The bird feeder of claim 43, wherein the first stopping means is crimped into the second portion of the generally helical member.

48. The bird feeder of claim 43, wherein the second stopping means is secured to the second portion of the generally helical member.

49. The bird feeder of claim 43, wherein the second stopping means of the second portion is a threaded cap nut.

50. The bird feeder of clam 24, wherein the bottom cap further comprises:
a receiving slot to receive the bottom end of the hollow body;
an overhang provided to fit at least partially over the bottom end of the hollow body; and
an O-ring to be inserted inside the receiving slot of the bottom cap and to receive the bottom end of the hollow body.

51. The bird feeder of claim 24, wherein the bottom cap further comprises a locking slot to receive the second portion of the generally helical member, the bottom cap being aligned in a predetermined manner, such that, in its locked position, the second portion of the generally helical member is received through the locking slot and the bottom receiving means of the hollow body.
